(19) United States
(12) Patent Application Publication
(10) Pub. No.: US 2006/0140650 A1
(43) Pub. Date: Jun. 29, 2006

(54) Image forming apparatus, toner counter and toner consumption calculating method

(75) Inventor: Shinsuke Yokote, Nagano-ken (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/293,865

(22) Filed: Dec. 2, 2005

(30) Foreign Application Priority Data
Dec. 14, 2004 (JP) 2004-360766
Dec. 21, 2004 (JP) 2004-368902

(51) Int. Cl. G03G 15/08

(52) U.S. Cl. 399/27; 399/49

(57) ABSTRACT

The number of toner dots to be formed or tone values of the respective dots are integrated and thus found count is multiplied by a predetermined coefficient, thereby calculating a toner consumption amount. As a value (E1 or E2) to which exposure power E is set to attain a target density Dlow is different from a theoretical optimal value (Eopt1 or Eopt2), an image density becomes slightly different from the target density, which causes an error in calculating the toner consumption amount. To suppress this, the coefficient substituted in a formula for calculating the toner consumption amount is changed depending upon a deviation (ΔE1 or ΔE2) between the set value and the optimal value.

### CROSS REFERENCE TO RELATED APPLICATION

The disclosure of Japanese Patent Applications enumerated below including specifications, drawings and claims is incorporated herein by reference in its entirety:

No. 2004-360766 filed on Dec. 14, 2004; and

No. 2004-368902 filed on Dec. 21, 2004.

### BACKGROUND OF THE INVENTION

1. Field of the Invention

The present invention relates to a technique for calculating a toner consumption amount required for formation of an image in an image forming apparatus which forms an image using toner.

2. Description of the Related Art

It is necessary for an electrophotographic image forming apparatus, such as a printer, a copier machine and a facsimile machine, which forms an image using toner to grasp a toner consumption amount or a remaining toner amount for the purpose of maintenance such as replenishment of toner. Noting this, techniques for accurately calculating a toner consumption amount (hereinafter referred to as “toner count techniques”) have been proposed. For instance, according to the toner consumption detecting method described in Japanese Unexamined Patent Application Publication No. 2002-174929 for example, printed dot strings are classified into plural patterns in accordance with how the dots are contiguous to each other and their frequencies of occurrence are counted individually. The counts are multiplied by predetermined coefficients and then added together, whereby the total toner consumption amount is calculated. In this manner, the toner consumption amount is calculated at a high accuracy regardless of the non-linearity between the number of dots and an adhering toner amount which is attributable to a difference in terms of the dot contiguity.

The conventional technique described above is feasible on the premise that a relationship between the number of dots and the adhering toner amount is always constant. However, in an actual apparatus, this relationship is not always constant but rather may change owing to various factors such as the circumstance under which the apparatus is used, a surrounding environment, etc. The conventional technique described above has a problem that it is not possible to deal with such a change, leaving a room for improvement with respect to the accuracy of toner consumption amount calculation.

### SUMMARY OF THE INVENTION

The invention has been made in light of this, and accordingly, aims at providing a technique for accurately calculating a toner consumption amount in an image forming apparatus.

In a first aspect of the invention related to the image forming apparatus, the toner counter and the toner consumption calculation method, to achieve the object above, a toner image (calibration patch image) is actually formed, the density of this image is detected, and a toner consumption amount is calculated based on the detected density and image data which correspond to a toner image to be formed. Since it is possible to calculate the toner consumption amount in accordance with the actual image density, regardless of whether thus formed image has a target density or not, it is possible to accurately calculate the amount of toner consumed for the image formation.

In a second aspect of the invention related to the toner counter and the toner consumption calculation method, to achieve the object above, a toner consumption amount is calculated based on discrepancy information which expresses the degree of a discrepancy of the actual density of a formed toner image from a target density, namely, an image density which this toner image is supposed to have, and image data which correspond to an image to be formed. According to the invention, the discrepancy information is introduced at the stage of calculating the toner consumption amount based on the image data, thereby reflecting the degree of the discrepancy between the actual density of the toner image and the target density. In this fashion, it is possible to calculate the toner consumption amount which more accurately reflects the actual consumption of toner. The invention thus makes it possible to accurately calculate a toner consumption amount in an image forming apparatus.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which shows an example of the structure of an image forming apparatus to which the invention is favorably applicable,

FIG. 2 is a block diagram of the electric structure of the image forming apparatus shown in FIG. 1;

FIG. 3 is a diagram which shows signal processing blocks of the apparatus;

FIG. 4 is a flow chart which shows a density control processing in the apparatus;

FIGS. 5A, 5B and 5C are drawings which show the image patterns of patch images;

FIG. 6 is a drawing which shows a relationship between the developing bias and the density of an image;

FIG. 7 is a drawing which shows a relationship between the exposure power and the density of an image;

FIG. 8 is a drawing which shows an example of the density of a halftone image as it is after the density control processing;

FIG. 9 is a drawing which shows a relationship between an adhering toner amount and the density of an image;

FIGS. 10A and 10B are drawings which show a relationship between a line gap and the adhering toner amount;

FIG. 11 is a drawing which shows the structure of the toner counter according to the first embodiment;

FIG. 12 is a drawing which shows how the proportional coefficient corresponds to the detected density of a calibration patch image;

FIG. 13 is a drawing which shows the locations of calibration patch images on the intermediate transfer belt;

FIGS. 14A, 14B, 14C and 14D are drawings which show timing for forming calibration patch images;

FIGS. 15A and 15B are drawings which show timing for forming calibration patch images in a color print mode;

FIG. 16 is a drawing which shows a relationship between the exposure power and the density of an image;

FIG. 17 is a drawing which shows the structure of the toner counter in the second embodiment;

FIG. 18 is a drawing which shows a relationship between the OFF-gap and the adhering toner amount;

FIG. 19 is a drawing which shows an example of setting the weighting coefficients; and

FIG. 20 is a drawing which shows other structure of the toner counter.

### DETAILED DESCRIPTION OF THE PREFERRED EMBODIMENTS

### Principle of First Invention

In this type of image forming apparatus, while the respective sections of the apparatus are so structured and controlled that a predetermined image density will be achieved, there may sometimes be a difference between a target density and the density of an actually formed image. For instance, the image density fluctuates depending upon a surrounding environment around the apparatus, the degree of deterioration, a difference in terms of set operating conditions, etc. Although a deviation of the image density from the target density, if small, will not exert a problematic influence over the quality of the image, the deviation emerges as a major problem against calculation of a toner consumption amount based on image data. This is because an error in calculating a toner consumption amount attributable to a change of the image density, even if small for one page of the formed image, becomes more significant as the number of pages increases.

This problem similarly occurs even in an apparatus which controls the density of an image by means of adjustment of operating conditions for the apparatus based on the detected density of a patch image. This is because operating conditions are adjusted using a few types of typical test images according to this type of density controlling technique in general, and hence, a match between the density of a freely chosen image and a target density is not necessarily guaranteed. Further, since whether adjusted operating conditions are optimal is not confirmed in many instances, the density of an actually formed image may be different from a target. In addition, due to a constraint with respect to the structure of the apparatus, such operating conditions which will achieve a target image density may not be realized.

Noting this, according to the invention, a toner image (calibration patch image) is actually formed, the density of this image is detected, and a toner consumption amount is calculated based on the detection result and image data which correspond to a toner image to be formed. Since it is possible to calculate the toner consumption amount in accordance with the actual image density, regardless of whether thus formed image has a target density or not, it is possible to accurately calculate the amount of toner consumed for the image formation.

As a specific calculation method, the toner consumption amount may be calculated by multiplying the number of dots to be formed which is calculated based on the image data by a coefficient which is set based on the detected density. That is, since a toner consumption amount is generally proportional to the number of toner dots to be formed, an approximate toner consumption amount is calculated by multiplying the total number of toner dots formed during a predetermined unit period, e.g., per page or job by a constant proportional coefficient (a value which corresponds to a toner adherence rate per dot). In this case, the coefficient to be multiplied over the number of toner dots should preferably reflect the detected density of the calibration patch image. The “toner dots” herein referred to are dots to which toner must adhere within a toner image which is grasped as the group of many dots.

Alternatively, the toner consumption amount may be calculated by multiplying the integrated value of grayscale values of toner dots to be formed which is calculated based on the image data by a coefficient which is set based on the detected density. In the event that one dot is expressed as multi-tone value for reproduction of halftone, depending upon the tone value, the amount of toner consumed for formation of this dot changes. In light of this, instead of merely counting the number of dots, the number of dots may be counted while weighting according to the tone value. That is, the number of dots may be replaced with the integrated value of the tone values of the respective dots.

Further, as described above, the invention is useful also to an apparatus which forms a toner image which serves a control patch image, adjusts operating conditions for the apparatus based on the detected density of this image and executes control processing of controlling the density of the toner image.

It is ideal in this case that a calibration patch image is formed under operating conditions which are set as a result of execution of the control processing. In addition, since the density of an image fluctuates after execution of the control processing and hence adjustment of the operating conditions, it is necessary to change a formula for calculating a toner consumption amount after execution of the control processing. In other words, it is desirable to form the calibration patch image immediately after execution of the control processing. Further, the image pattern of the calibration patch image to be formed may be specified for the purpose of improving the accuracy of toner consumption amount calculation and may therefore be different image pattern from that of the control patch image. In short, an image pattern which is suitable for improvement of the accuracy of calculating a toner consumption amount naturally disagrees with an image pattern which is suitable for control of the operating conditions for the apparatus, and for this reason, images which serve the best for the respective purposes should be used as the calibration patch image and the control patch image.

An image formation request from outside may not be received immediately after execution of the control processing. Noting this, the calibration patch image may be formed at different timing than immediately after execution of the control processing, e.g., immediately before or after toner image formation, which is the first action to exercise in response to an image formation request from outside, following execution of the control processing, and a toner consumption amount demanded for this toner image formation may then be calculated based on the detected density of this calibration patch image and image data which correspond to this toner image. This ensures calculation of the toner consumption amount based on the detected density of the calibration patch image in an approximately the same circumstance as that for actual toner image formation, and hence, further improves the calculation accuracy. In this case, the calibration patch image may be formed either before or after the toner image is formed, to the extent that the calibration patch image is formed in time for calculation of the toner consumption amount demanded by the toner image formation which takes place in response to the image formation request. Further, when plural pages of toner images need be formed, the calibration patch images may be formed between these pages.

In an apparatus which is capable of executing a monochrome image formation mode for forming a monochrome image consisting of a toner image of one toner color and a color image formation mode for forming a color image which is obtained by laying toner images of plural mutually different colors one atop the other, when it is the monochrome image formation mode that will be executed first after execution of the control processing above, the calibration patch image may be formed only for the toner color which is used to form this monochrome image.

When the color image formation mode which should first follow execution of the control processing is executed, the calibration patch images may be formed in the all toner colors. At this time, in the event that the calibration patch image has already been formed and its density has already been detected as the color of the monochrome image among all colors, the calibration patch images may be formed in the toner colors except the monochrome color. This eliminates uneconomic formation of the calibration patch images at unnecessary timing and makes it possible to obtain information needed to calculate a toner consumption amount, namely, the detected densities of the calibration patch images at necessary timing on each toner color.

In the event that an image forming apparatus having the structure above comprises an image carrier which is capable of temporarily carrying a toner image, a calibration patch image may be formed in a different region from an region within a surface of the image carrier which carries a toner image which is formed in response to an image formation request from outside. In this fashion, it is possible to form a toner image which corresponds to the image formation request from outside irrespective of calibration patch image formation, and hence, prevent lowering of the throughput owing to calibration patch image formation.

The calibration patch images are preferably halftone images. This is because according to the experiments which the inventor of the invention conducted, a fluctuation of a toner consumption amount is remarkable particularly when a toner image is a halftone image. Where such an image having an image pattern which would greatly fluctuate is used as a calibration patch image and a toner consumption amount is calculated in accordance with the detected density of this image therefore, the effect of the invention is best achieved.

### Principle of Second Invention

Even if an image to be formed is the same, the amount of toner consumed for formation of this image may fluctuate because of the circumstance in which the apparatus is used, a surrounding environment, etc. Further, prioritizing an economic use of toner for instance rather than an image quality, an image may be formed under a condition which is intentionally off a target density. Rigid application of a calculation method ignoring such fluctuations or a density difference will result in a great calculation error.

Noting this, the discrepancy information is introduced at the stage of calculating a toner consumption amount based on image data, thereby reflecting the degree of a discrepancy between the actual density of a toner image and a target density according to the invention. In this fashion, it is possible to calculate a toner consumption amount which more accurately reflects the actual consumption of toner. The invention thus makes it possible to accurately calculate a toner consumption amount in the image forming apparatus. For example, when the discrepancy information tells that the actual density of a toner image to be formed will be higher than a target density, calculation may be modified such that a greater toner consumption amount will be calculated than what will be calculated in the opposite situation. Which side between the higher density side and the lower density side an actual image density is shifted toward in comparison with a target density or to what extent the actual image density is shifted can be estimated from various types of information as the examples suggested below.

The discrepancy information may not necessarily be information which directly expresses a difference between the actual density and the target density, but may be information which expresses a difference between actual operation conditions for the apparatus and ideal operating conditions which are operating conditions under which the target density is obtainable. This is because it is possible to estimate the degree to which the actual density has shifted from the target density from such information. Such information is obtainable even without measurement of the actual density of a toner image, and therefore, can be suitably used as the discrepancy information according to the invention.

Among image forming apparatuses of this type is such an apparatus whose structure realizes adjustment of operating conditions by appropriately changing and setting a density controlling factor which influences an image density. In the case of an apparatus of this type, it is sometimes impossible to set the density controlling factor to a theoretical optimal value because of a constraint with respect to the structure of the apparatus. That is when a theoretical optimal value is outside the range in which the density controlling factor can be changed, and when the density controlling factor can have no other value but a discrete value, for example. In such a situation, it is practical to set the density controlling factor such that the density controlling factor will be the closest to an optimal value within a possible range. Although this will result in a toner consumption amount deviation attributable to the difference between the set value of the density controlling factor and the optimal value, the difference is known and it is therefore possible to estimate the toner consumption amount deviation as well.

Further, it is known that in an apparatus of this type, an image density fluctuates owing to a change of a surrounding environment around the apparatus such as a temperature and humidity and that a toner consumption amount also changes. A change of the surrounding environment may therefore be used as the discrepancy information. In the case of an apparatus which performs density control at predetermined timing in particular, it is possible to estimate the trend of toner consumption amount fluctuations based on a difference between the environment in which the density control is executed and the current environment.

Of course, the density of an actually formed toner image may be detected and compared with an ideal density value of this toner.

A specific method of calculating a toner consumption amount based on the discrepancy information and image data will be described later with reference to examples. The number of toner dots to be formed which is calculated from the image data may be multiplied by a coefficient which is set based on the discrepancy information for instance to thereby calculate the toner consumption amount. Alternatively, the integrated value of tone values of the respective toner dots to be formed which is calculated based on the image data may be multiplied by a coefficient which is set based on the discrepancy information.

Further, an approximate toner consumption amount may be calculated based on the image data and then corrected based on the discrepancy information. In this case, for calculation of the approximate toner consumption amount, a known calculation method may be applied such as multiplication of the number of toner dots which is calculated from the image data or the integrated value of tone values of the toner dots for instance by a constant coefficient. Correction of the approximate value based on the discrepancy information attains more accurate toner consumption amount calculation than where a known toner count technique is used.

### Structure of Apparatus

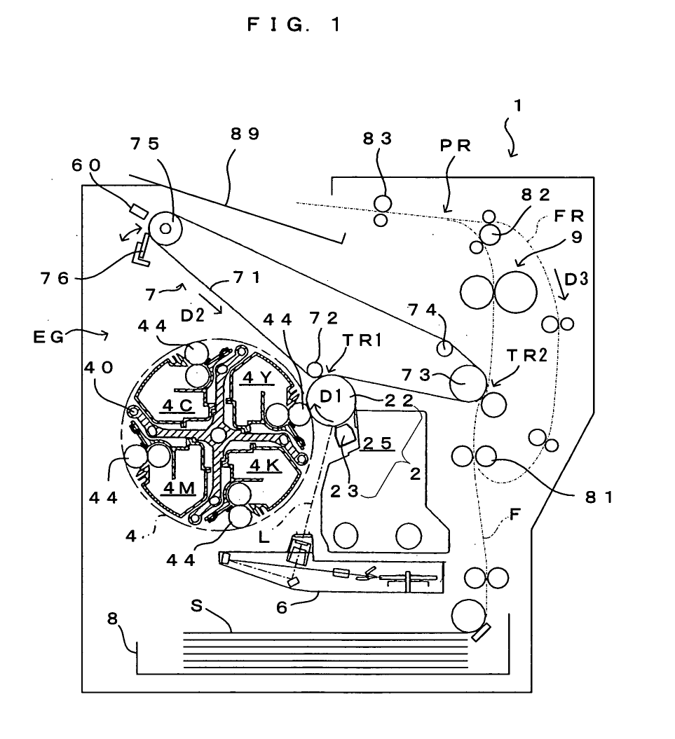

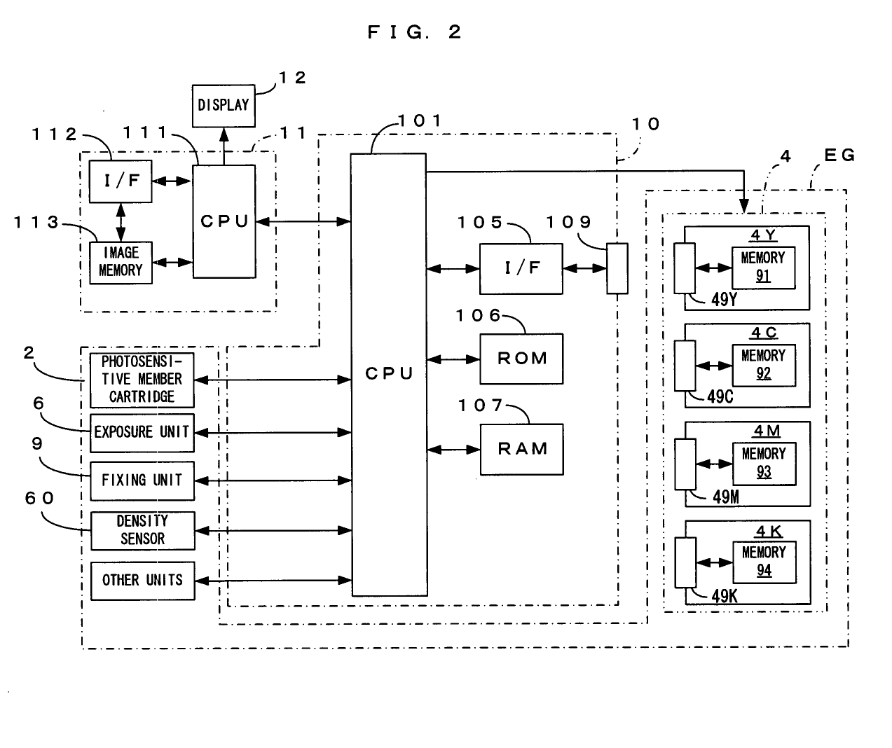

FIG. 1 is a drawing which shows an example of the structure of an image forming apparatus to which the invention is favorably applicable. FIG. 2 is a block diagram of the electric structure of the image forming apparatus shown in FIG. 1. The illustrated apparatus 1 is an apparatus which overlays toner in four colors of yellow (Y), cyan (C), magenta (M) and black (K) one atop the other and accordingly forms a full-color image, or forms a monochrome image using only black toner (K). In the image forming apparatus 1, when an image signal is fed to a main controller 11 from an external apparatus such as a host computer, a predetermined image forming operation is performed. That is, an engine controller 10 controls respective portions of an engine part EG in accordance with an instruction received from the main controller 11, and an image which corresponds to the image signal is formed on a sheet S.

In the engine part EG, a photosensitive member 22 is disposed so that the photosensitive member 22 can freely rotate in the arrow direction D1 shown in FIG. 1. Around the photosensitive member 22, a charger unit 23, a rotary developer unit 4 and a cleaner 25 are disposed in the rotation direction D1. A predetermined charging bias is applied upon the charger unit 23, whereby an outer circumferential surface of the photosensitive member 22 is charged uniformly to a predetermined surface potential. The cleaner 25 removes toner which remains adhering to the surface of the photosensitive member 22 after primary transfer, and collects the toner into a used toner tank which is disposed inside the cleaner 25. The photosensitive member 22, the charger unit 23 and the cleaner 25, integrated as one, form a photosensitive member cartridge 2. The photosensitive member cartridge 2 can be freely attached to and detached from a main section of the apparatus 1 as one integrated unit.

An exposure unit 6 emits a light beam L toward the outer circumferential surface of the photosensitive member 22 which is thus charged by the charger unit 23. The exposure unit 6 makes the light beam L expose on the photosensitive member 22 in accordance with an image signal fed from the external apparatus and forms an electrostatic latent image which corresponds to the image signal.

The developer unit 4 develops thus formed electrostatic latent image with toner. The developer unit 4 comprises a support frame 40 which is disposed for free rotations about a rotation shaft which is perpendicular to the plane of FIG. 1, and also comprises a yellow developer 4Y, a cyan developer 4C, a magenta developer 4M and a black developer 4K which house toner of the respective colors and are formed as cartridges which are freely attachable to and detachable from the support frame 40. The engine controller 10 controls the developer unit 4′. The developer unit 4 is driven into rotations based on a control instruction from the engine controller 10. When the developers 4Y, 4C, 4M and 4K are selectively positioned at a predetermined developing position which abuts on the photosensitive member 22 or is away a predetermined gap from the photosensitive member 22, toner of the color corresponding to the selected developer is supplied onto the surface of the photosensitive member 22 from a developer roller 44 disposed to the selected developer which carries toner of this color and has been applied with the predetermined developing bias. As a result, the electrostatic latent image on the photosensitive member 22 is visualized in the selected toner color.

Non-volatile memories 91 through 94 which store information regarding the respective developers are disposed to the developers 4Y, 4C, 4M and 4K. As one of connectors 49Y, 49C, 49M and 49K disposed to the respective developers selected as needed is connected with a connector 109 which is disposed to the main section, a CPU 101 of the engine controller 10 and one of the memories 91 through 94 communicate with each other. In this manner, the information regarding the respective developers is transmitted to the CPU 101 and the information inside the respective memories 91 through 94 is updated and stored.

A toner image developed by the developer unit 4 in the manner above is primarily transferred onto an intermediate transfer belt 71 of a transfer unit 7 in a primary transfer region TR1. The transfer unit 7 comprises the intermediate transfer belt 71 which runs across a plurality of rollers 72 through 75, and a driver (not shown) which drives a roller 73 into rotations to thereby rotate the intermediate transfer belt 71 along a predetermined rotation direction D2. For transfer of a color image on the sheet S, toner images in the respective colors on the photosensitive member 22 are superposed one atop the other on the intermediate transfer belt 71, thereby forming a color image. Further, on the sheet S unloaded from a cassette 8 one at a time and transported to a secondary transfer region TR2 along a transportation path F, the color image is secondarily transferred.

At this stage, for the purpose of correctly transferring the image held by the intermediate transfer belt 71 onto the sheet S at a predetermined position, the timing of feeding the sheet S into the secondary transfer region TR2 is managed. To be more specific, there is a gate roller 81 disposed in front of the secondary transfer region TR2 on the transportation path F. As the gate roller 81 rotates in synchronization to the timing of rotations of the intermediate transfer belt 71, the sheet S is fed into the secondary transfer region TR2 at predetermined timing.

Further, the sheet S now bearing the color image is transported to a discharge tray 89, which is disposed to a top surface of the main section of the apparatus, through a fixing unit 9, a pre-discharge roller 82 and a discharge roller 83. Meanwhile, when images are to be formed on the both surfaces of the sheet S, the discharge roller 83 starts rotating in the reverse direction upon arrival of the rear end of the sheet S, which carries the image on its one surface as described above, at a reversing position PR located behind the pre-discharge roller 82, thereby transporting the sheet S in the arrow direction D3 along a reverse transportation path FR. While the sheet S is returned back to the transportation path F again before arriving at the gate roller 81, the surface of the sheet S which abuts on the intermediate transfer belt 71 in the secondary transfer region TR2 and is to receive a transferred image is at this stage opposite to the surface which already bears the image. In this fashion, it is possible to form images on the both surfaces of the sheet S.

Further, there are a density sensor 60 and a cleaner 76 in the vicinity of the roller 75. The density sensor 60 optically detects a toner amount which constitutes a toner image which is formed as a patch image on the intermediate transfer belt 71 when needed. The density sensor 60 irradiates light toward the patch image, receives reflection light from the patch image, and outputs a signal corresponding to a reflection light amount. The cleaner 76 can be attached to and detached from the intermediate transfer belt 71. When abutting on the intermediate transfer belt 71 as needed, the cleaner 76 scrapes off the toner remaining on the intermediate transfer belt 71 and the toner which constitutes the patch image.

Further, as shown in FIG. 2, the apparatus 1 comprises a display 12 which is controlled by a CPU 111 of the main controller 11. The display 12 is formed by a liquid crystal display for instance, and shows predetermined messages which are indicative of operation guidance for a user, a progress in the image forming operation, abnormality in the apparatus, the timing of exchanging any one of the units, etc.

In FIG. 2, denoted at 113 is an image memory which is disposed to the main controller 11, so as to store an image which is fed from an external apparatus such as a host computer via an interface 112. Denoted at 106 is a ROM which stores a calculation program executed by the CPU 101, control data for control of the engine part EG, etc. Denoted at 107 is a memory (RAM) which temporarily stores a calculation result derived by the CPU 101, other data, etc.

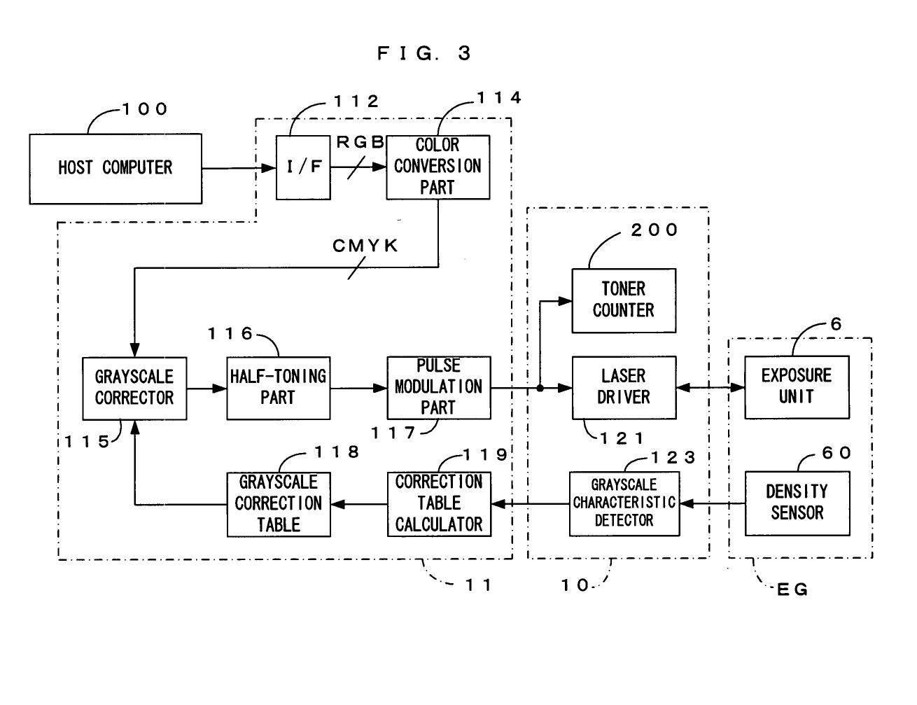

FIG. 3 is a diagram which shows signal processing blocks of the apparatus. The image forming apparatus operates as follows. When an image signal is inputted from an external apparatus such as a host computer 100, the main controller 11 performs a predetermined signal processing on the input image signal. The main controller 11 includes function blocks such as a color converter 114, a tone correction section 115, a half-toning section 116, a pulse modulator 117, a tone correction table 118, a tone-correction-table operation section 119.

In addition to the CPU 101, the ROM 106, and the RAM 107 shown in FIG. 2, the engine controller 10 further includes a laser driver 121 for driving a laser light source provided at the exposure unit 6, and a tone characteristic detector 123 for detecting a tone characteristic based on a detection result given by the density sensor 60, the tone characteristic representing a gamma characteristic of the engine EG.

In the main controller 11 and the engine controller 10, the function blocks may be implemented in hardware or otherwise, in software executed by the CPU 111, 101.

In the main controller 11 supplied with the image signal from the host computer 100, the color converter 114 converts RGB color data into CMYK color data, the RGB color data representing tone levels of RGB components of each pixel in an image corresponding to the image signal, the CMYK color data representing tone levels of CMYK components corresponding to the RGB components. In the color converter 114, the input RGB color data comprise 8 bits per color component for each pixel (or representing 256 tone levels), for example, whereas the output CMYK color data similarly comprise 8 bits per color component for each pixel (or representing 256 tone levels). The CMYK tone data outputted from the color converter 114 are inputted to the tone correction section 115.

The tone correction section 115 performs tone correction on the per-pixel CMYK data inputted from the color converter 114. Specifically, the tone correction section 115 refers to the tone correction table 118 previously stored in the non-volatile memory, and converts the per-pixel CMYK data inputted from the color converter 114 into corrected CMYK data according to the tone correction table 118, the corrected CMYK data representing corrected tone levels. An object of the tone correction is to compensate for the variations of the gamma characteristic of the engine EG constructed as described above, thereby allowing the image forming apparatus to maintain the overall gamma characteristic thereof in an idealistic state at all times.

The corrected CMYK tone data thus obtained are inputted to the half-toning section 116. The half-toning section 116 performs a half-toning process, such as an error diffusion process, a dithering process or a screening process, and then supplies the pulse modulator 117 with the half-toned CMYK tone data comprising 8 bits per color component for each pixel. The content of the half-toning process varies depending upon the type of an image to be formed. A process of the most suited content for the image is selected based on judgment standards according to which the subject image is classified as any one of a monochromatic image, a color image, a line drawing and a graphic image. Then, the selected process is executed.

The half-toned CMYK tone data inputted to the pulse modulator 117 are represented by a multivalued signal which indicates respective sizes and arrays of CMYK toner dots, to which CMYK color toners are made to adhere and which constitute one pixel. Based on such half-toned CMYK tone data thus received, the pulse modulator 117 generates a video signal for pulse width modulation of an exposure laser pulse for forming each of CMYK color images, the exposure laser provided at the engine EG. Then, the resultant signal is outputted to the engine controller 10 via a video interface not shown. In response to the video signal, the laser driver 121 provides ON/OFF control of a semiconductor laser of the exposure unit 6 whereby an electrostatic latent image of each of the color components is formed on the photosensitive member 22. The image corresponding to the image signal is formed in this manner.

In the image forming apparatuses of this type, the gamma characteristic varies from apparatus to apparatus. Furthermore, the apparatus per se encounters the variations of the gamma characteristic thereof according to the use conditions thereof. In order to eliminate the influences of the varied gamma characteristics on the image quality, a tone control process is performed in a predetermined timing so as to update the contents of the tone correction table 118 based on measurement results of image density.

The tone control process is performed as follows. Toned patch images for tone correction, prepared for measurement of the gamma characteristic, are formed on the intermediate transfer belt 71 by means of the engine EG A density of each of the toned patch images is detected by the density sensor 60. Based on signals from the density sensor 60, the tone characteristic detector 123 generates a tone characteristic (the gamma characteristic of the engine EG) which relate the individual tone levels of the toned patch images with the detected image densities. The resultant tone characteristic is outputted to the tone-correction table operation section 119 of the main controller 11. The tone-correction table operation section 119, in turn, operates tone correction table data based on the tone characteristic supplied from the tone characteristic detector 123. The tone correction table data are used for compensating for the measured tone characteristic of the engine EG in order to obtain an idealistic tone characteristic. Then, the tone-correction table operation section 119 updates the tone correction table 118 to the operation results. The tone correction table 118 is re-defined in this manner. Thus, the image forming apparatus is allowed to form images of a consistent quality regardless of the variations of the gamma characteristic thereof or the time-related variations thereof.

Further, in this image forming apparatus, for calculation of the toner consumption amount, the engine controller 10 comprises a toner counter 200 (described later) which calculates the toner consumption amount based on a pulse signal (video signal) which is output from the pulse modulation part 117 of the main controller 11 as shown in FIG. 3. A toner image is composed of many toner dots, and therefore, calculation of the total amount of toner which is consumed for formation of the respective toner dots identifies the total toner consumption amount. From the results of various experiments, the inventor of the invention has conceived a toner counter which will be described in detail later.

In the image forming apparatus 1, at predetermined timing which may be right after power on, after restoration from sleep-state or the time at which the cumulative number of formed images reaches a predetermined count, the CPU 101 executes density control processing of forming a patch image, detecting the density of the patch image and adjusting operating conditions for the apparatus based on the detected density. This ensures that the densities of formed images stay constant. To be more specific, from among operation parameters for the respective sections of the apparatus, a developing bias (hereinafter denoted at the symbol Vb) to be applied upon the developer roller 44 and the intensity of the light beam L (hereinafter referred to as “exposure power E”) irradiated upon the photosensitive member 22 from the exposure unit 6 are adjusted for each toner color. As there are many known techniques as for this type of density control processing, the flow of the processing alone will now be briefly described.

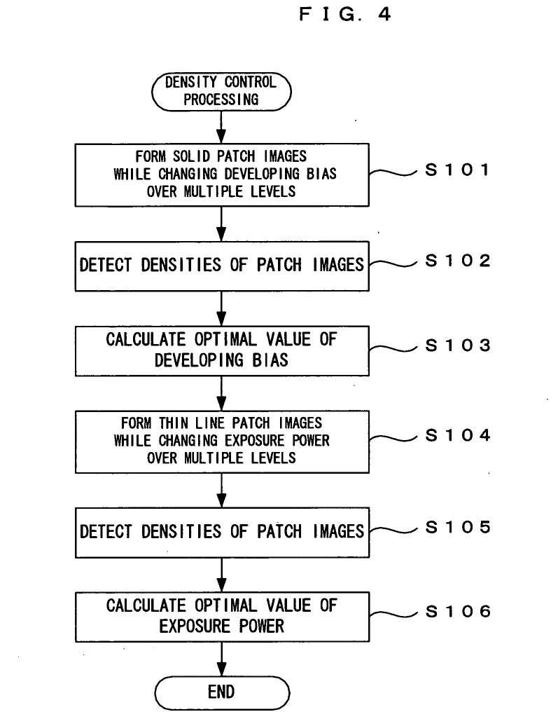

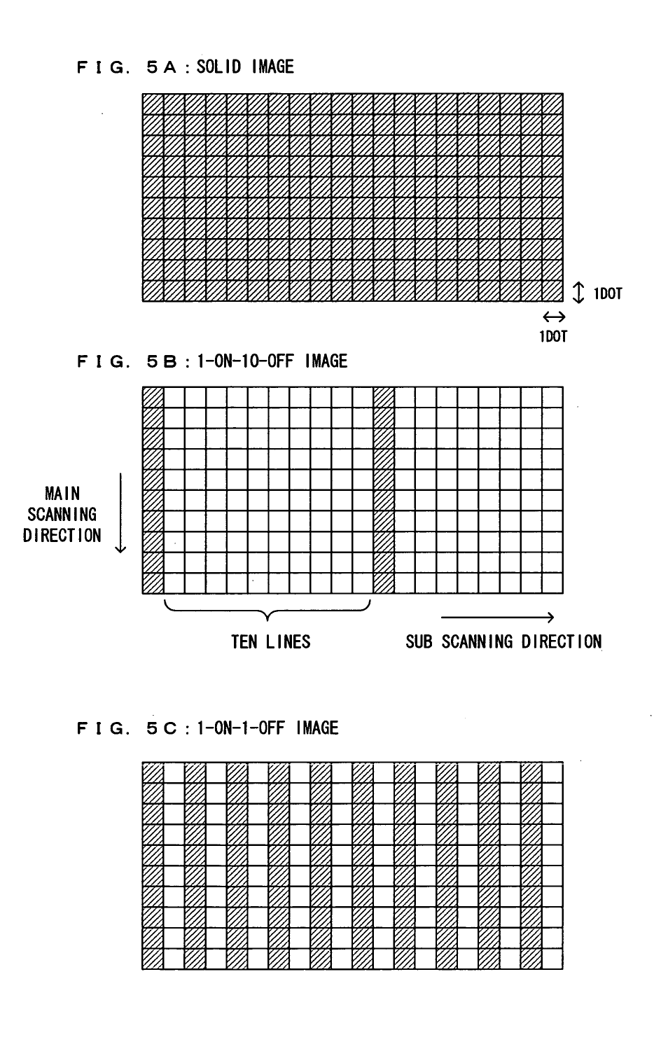

FIG. 4 is a flow chart which shows a density control processing in this apparatus. FIGS. 5A, 5B and 5C are drawings which show the image patterns of patch images. During this density control processing, the developing bias Vb is first adjusted. That is, first, while changing the developing bias over multiple levels (which are five levels in this example), predetermined patch images are formed on the surface of the intermediate transfer belt 71 at thus varied bias values (Step S101). The patch images formed in this manner are solid images which have the pattern shown in FIG. 5A for example. The density sensor 60 detects the densities of the patch images formed in this manner (Step S102), and based on the detected densities, an optimal developing bias value is calculated (Step S103).

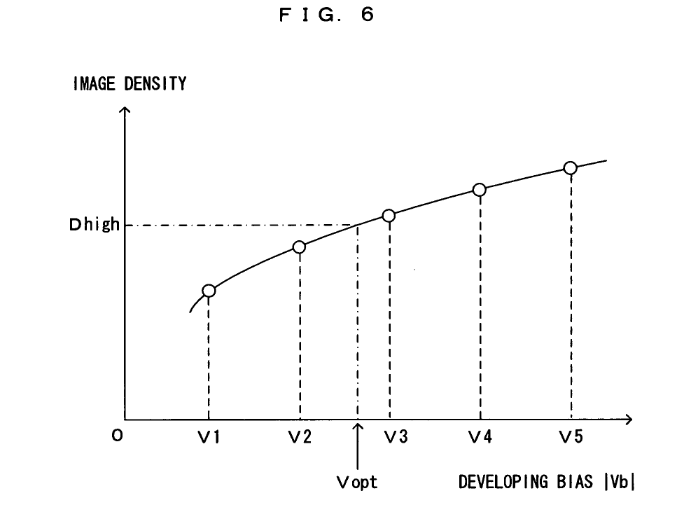

FIG. 6 is a drawing which shows a relationship between the developing bias and the density of an image. As the value |Vb| of the developing bias increases, the image density increases as well. The relationship between the developing bias and the image density is identified from the detected densities of patch images at the developing bias values V1 through V5, as denoted at the solid curve in FIG. 6. From this relationship, an optimal developing bias value Vopt at which the image density will become a target value Dhigh is calculated.

The density control processing will be further described while referring back to FIG. 4. The next is adjustment of the exposure power. With the developing bias set to the optimal value Vopt described above, while changing the exposure power over multiple levels (which are eight levels in this example), predetermined patch images are first formed at thus varied exposure power levels (Step S104). The patch images formed in this manner are thin line images which have the pattern shown in FIG. 5B. The level of the exposure power influences the depth of a latent image on the photosensitive member 22. Hence, the density of a thin line image is more influenced than that of a solid image is influenced. It is therefore preferable to use a patch image whose image pattern is comprised of thin lines, for adjustment of the exposure power. It is also preferable that the lines are spaced apart from each other so that they will not interfere with each other. A one-ON-ten-OFF image as that shown in FIG. 5B is therefore used. The one-ON-one-OFF image shown in FIG. 5C is used for calibration of the toner counter in a first embodiment which will be described later, and the details of this will be described later.

The density sensor 60 detects the densities of the thin line patch images formed at the respective exposure power levels (Step S105), and based on thus detected densities, an optimal value of the exposure power is calculated (Step S106). In this apparatus 1, the value of the exposure power may be set to any one of the eight levels E1 through E8 but can not be set to any other value.

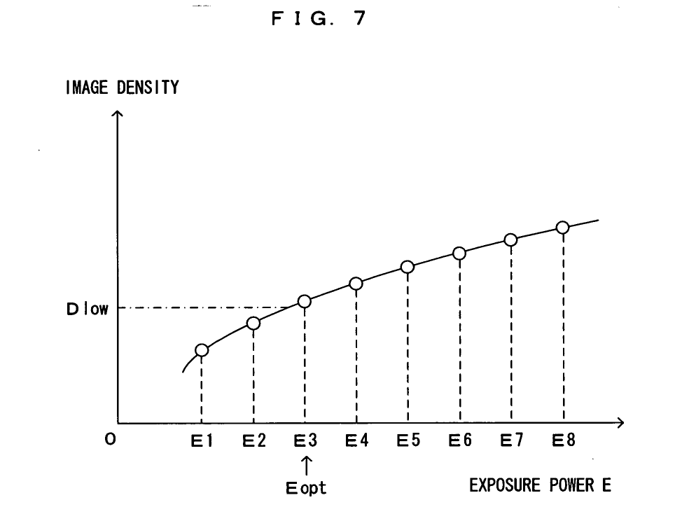

FIG. 7 is a drawing which shows a relationship between the exposure power and the density of an image. As shown in FIG. 7, from the detected densities of the patch images formed at the exposure power values E1 through E8, the relationship between the exposure power and the image density is found. From this relationship, a value of the exposure power (the value E3 in the example shown in FIG. 7) at which the image density will become the closest to a target value Dlow is chosen as an optimal value Eopt.

Once the optimal value Vopt and the optimal value Eopt respectively of the developing bias and the exposure power have been calculated in this fashion, the developing bias Vb and the exposure power E will be set to these optimal values in subsequent image formation. This ensures that each type of image will have a desired image density.

Two embodiments will now be described which are related to calculation of a toner consumption amount which the image forming apparatus having the structure above demands for formation of an image.

### First Embodiment

As described above, in this image forming apparatus 1, although the densities of images remain almost constant owing to the density control processing which is executed when needed, a toner consumption amount could fluctuate instead of remaining always constant. One of the reasons is that possible discrepancies of the optimal values of the developing bias and the exposure power calculated in the manner described above from true optimal values due to a density detection error, a calculation error, etc. In addition, since the optimal value Eopt of the exposure power is selected from among those values to which the exposure power can be set because of the structure of the apparatus as described above, the optimal value Eopt may be different from an exact optimal value. The other causes below also make the toner consumption amount fluctuate.

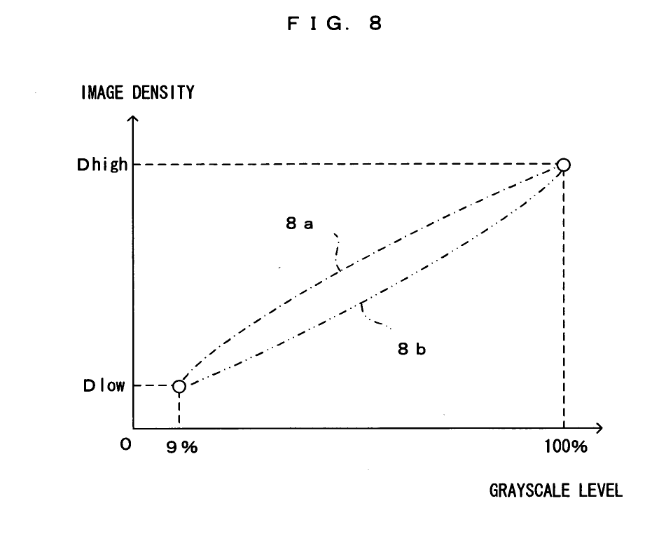

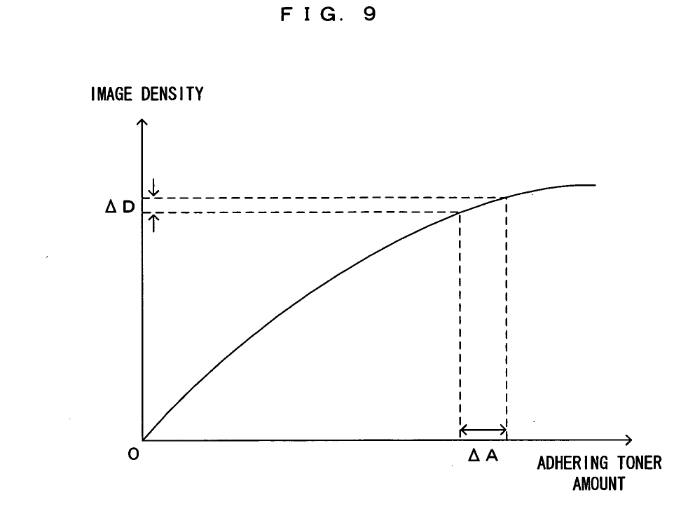

FIG. 8 is a drawing which shows an example of the density of a halftone image as it is after the density control processing. FIG. 9 is a drawing which shows a relationship between an adhering toner amount and the density of an image. During the density control processing described above, operating conditions for the apparatus are adjusted in accordance with the detected densities of two types of patch images, namely, solid images and one-ON-ten-OFF images. If converted into the tone level of a multi-tone image, these images are about 100% and 9% respectively. In short, as expressed by the curves 8a and 8b in FIG. 8, even when target densities are met at these two tone levels, the densities of freely chosen halftone images having the other tone levels may become different from each other, thereby fluctuating the toner consumption amount. For example, among two apparatuses which have similarly executed the density control processing, the apparatus exhibiting a characteristic expressed by the curve 8a forms a halftone image denser and hence demands a greater toner consumption amount than the apparatus exhibiting a characteristic expressed by the curve 8b does.

In addition, as shown in FIG. 9, an adhering toner amount per unit surface area on the intermediate transfer belt 71 and the density of an image are not in a proportional relationship in a strict sense, and an increase of the image density tends to saturate as an adhering toner amount increases. Hence, even a slight image density difference ΔD which is too small to recognize for human eyes for instance may have a relatively large difference ΔA in terms of the adhering toner amount.

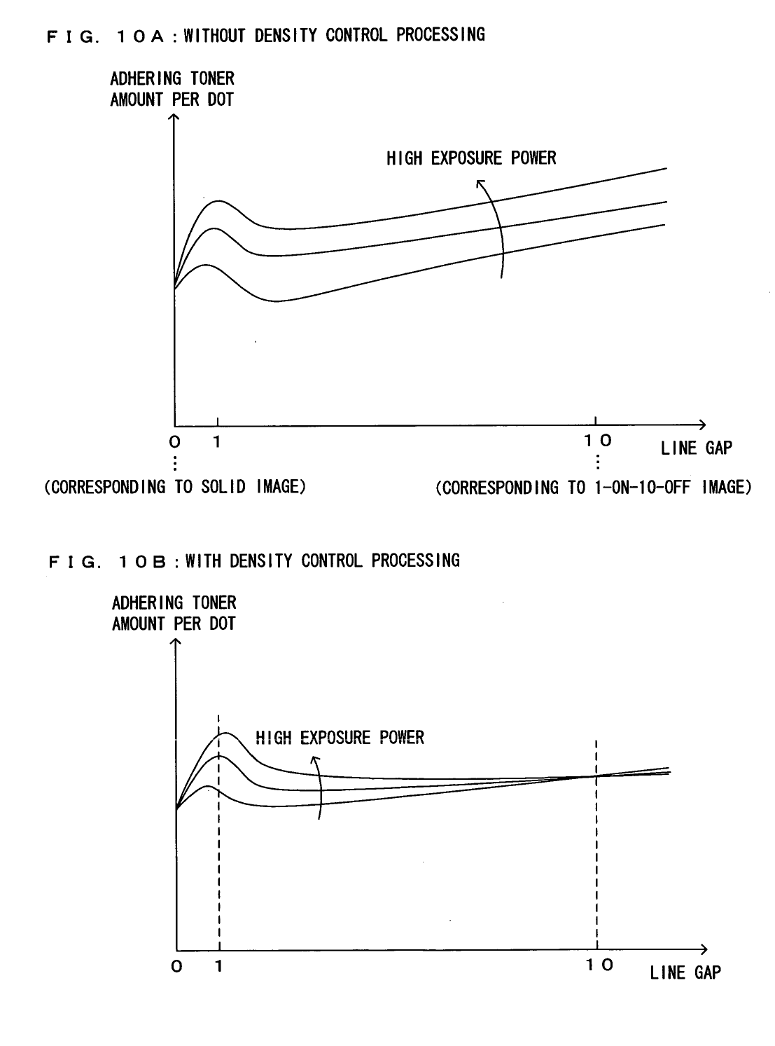

FIGS. 10A and 10B are drawings which show a relationship between a line gap and the adhering toner amount. The inventors of the invention tested images composed of mutually parallel 1-dot lines to see how the adhering toner amount per dot would change when the line gap between the lines was changed. The test result in FIG. 10A corresponds to where the value to which the exposure power was set was changed without executing the density control processing. As shown in FIG. 10A, the adhering toner amount greatly changes depending upon the line gap (the change is particularly large near the line gap 1) and also depending upon the set value of the exposure power.

Meanwhile, the test result in FIG. 10B corresponds to where the density control processing was executed. Even when the exposure power is set to different values as a result of the density control processing, the adhering toner amount remains approximately constant for the line gap of zero which corresponds to a solid image (FIG. 5A) and the line gap of ten which corresponds to a one-ON-ten-OFF image (FIG. 5B). However, near the line gap of one where the adhering toner amount greatly changes, the adhering toner amount greatly changes depending upon the value to which the exposure power is set.

Even when the density control processing maintains approximately constant densities of images, a toner consumption amount may fluctuate due to various reasons. To prevent occurrence of a deterioration of an image at unexpected timing because of toner shortage, a conventional toner counter is generally configured such that a theoretical toner consumption amount it calculates is greater than an actual toner consumption amount. When configured as such however, a toner counter determines that toner is in shortage even though there still is toner available within a developer in reality, inviting a problem that toner will not be used to the end.

In light of this problem, in this embodiment, after execution of the density control processing, calibration patch images are actually formed for the purpose of improving the accuracy of calculating a toner consumption amount, and the toner counter is calibrated in accordance with the detected densities of the patch images. This makes it possible to calculate a toner consumption amount accurately irrespective of fluctuated toner consumption amounts. Patch images formed for this purpose are preferably those images whose image pattern causes greatest adhering toner amount fluctuations. As such fluctuations tend to intensify when halftone images are formed, the patch images are preferably halftone images. In the apparatus according to this embodiment, as shown in FIG. 10B, the adhering toner amount fluctuates the most when the line gap is approximately one, and therefore, the one-ON-one-OFF image shown in FIG. 5C is used as a calibration patch image. The timing for forming patch images for toner consumption amount calculation will be described later.

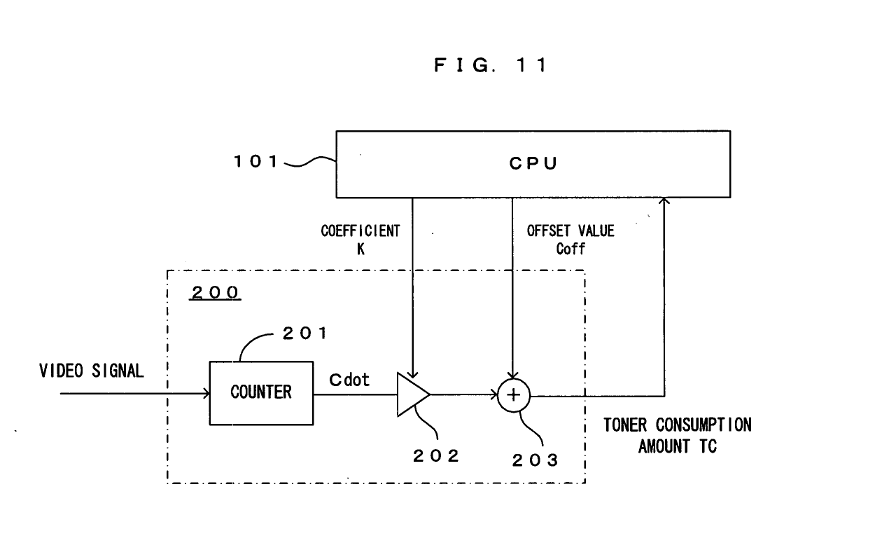

FIG. 11 is a drawing which shows the structure of the toner counter according to this embodiment. The toner counter 200 according to this embodiment comprises a counter 201 which integrates values related to dots which are to be formed in accordance with the video signal, a multiplier 202 which multiplies a count Cdot registered by the counter 201 by a coefficient K which the CPU 101 feeds, and an adder 203 which adds an offset value Coff which the CPU 101 feeds to the product calculated by the multiplier 202.

The counter 201 counts dots which are formed during a predetermined calculation period, e.g., per page or job for instance. In the event that each dot is expressed by two values of ON and OFF, the counter 201 may count the number of ON dots alone. When each dot is expressed by multi-tone value, the counter 201 may integrate tone values of the respective dots. The multiplier 202 multiplies the count Cdot registered during the calculation period by the coefficient K which corresponds to the toner adherence rate on each dot. The coefficient K is not a constant value, but is determined in accordance with the detected densities of calibration patch images.

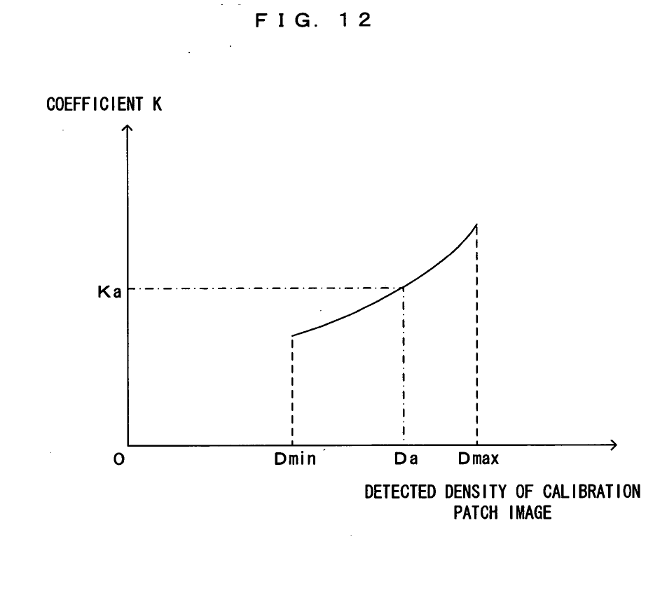

FIG. 12 is a drawing which shows how the proportional coefficient corresponds to the detected density of a calibration patch image. When the density of a calibration patch image is a relatively high density, the adhering toner amount per dot is greater than where the density is a low density (FIG. 10B) and so is the toner consumption amount. Noting this, the coefficient K is determined so that the proportional coefficient K to be multiplied upon the count Cdot is larger as a calibration patch image is denser. For calculation of the coefficient K, a candidate value corresponding to the detected density may be selected from among candidate values which are compiled as a table based on a pre-calculated relationship between the density of a calibration patch image and the toner adherence rate, or alternatively, the coefficient K may be determined by substituting the detected density value in a predetermined formula. For instance, when the pre-calculated relationship between the density of a calibration patch image and the toner adherence rate is expressed as the solid curve in FIG. 12 and Da is the detected density of an actually formed calibration patch image, a value Ka corresponds to Da is used as the proportional coefficient K.

Since the densities of images are controlled through the density control processing, fluctuations of the densities of calibration patch images can not become unreasonably large but should remain within a certain range. Hence, in the event that the value of the detected density of a calibration patch image is extremely far from a predicted value, it is possible that something is wrong with the apparatus, e.g., failed execution of the density control processing or the absence of toner within a developer. When the value of the detected density of a calibration patch image is outside an appropriate range which is defined between a predicted maximum value Dmax and a predicted minimum value Dmin, predetermined error processing is performed without setting the coefficient K based on this detected density value. The error processing may be re-execution of the density control processing, or suspension of the apparatus' operation and a predetermined error message shown by the display 12 to encourage a user to inspect the apparatus.

The offset value Coff fed from the CPU 101 is then added to the product of the count Cdot registered by the counter 201 and the coefficient K. The offset value Coff is a value which corresponds to the amount of toner consumed without contribution to formation of an image corresponding to the image signal. Such toner may be toner which falls off from the developer roller 44; adheres to the photosensitive member 22 and causes fogging or which is splashed inside the apparatus, toner which is consumed inside the apparatus during control operations which aim at maintenance of the apparatus' capabilities, etc. Toner which is consumed for formation of various types of patch images in this embodiment is included in such toner. The amount of toner consumed in this manner relates to the operating time of the apparatus, the number of images formed, the operating conditions for the apparatus and the like, a toner consumption amount during this period is estimated from such information which the engine controller 10 manages and determined as the offset value Coff.

From these values, the total toner consumption amount TC during this period is calculated. In other words, by the formula below, the toner counter 200 calculates the total toner consumption amount TC:
TC=K·Cdot+Coff
The CPU 101 disposed to the engine controller 10 manages thus calculated toner consumption amount, and when necessary, the RAM 107 or the memory 91 or the like of each developer 4Y or the like stores thus calculated toner consumption amount. It is possible to estimate the amount of toner remaining inside each developer from the calculated value of the toner consumption amount, and therefore, for management of consumables for the apparatus, the display 12 may show a message demanding exchange of the developer when it is determined that the amount of toner remaining inside the developer has decreased down to or beyond a predetermined value.

The timing for forming a calibration patch image will now be described. Whichever timing the toner counter 200 is calibrated based on the value of the detected density of a calibration patch image, the calibration is basically effective. However, too frequent formation of calibration patch images merely consumes toner. Further, since execution of the density control processing changes the operating conditions for the apparatus and hence a toner consumption amount, calibration patch image formation prior to the density control processing is not very beneficial.

Meanwhile, as for an image formed after the density control processing, since optimal values of the developing bias and the exposure power calculated through the density control processing are applied to such an image, the toner counter 200 as it is newly calibrated is preferably used for toner consumption amount calculation for this image. It is not however always necessary to form a calibration patch image right after the density control processing. That is, it is desirable to form a calibration patch image after the density control processing but at such timing which permits use of a detected density value for toner consumption amount calculation for the first image to form after the density control processing.

The preferable timing is therefore at the time of accepting a next image formation request after the density control processing or the time immediately after the density control processing for instance. Where it is determined to form a calibration patch image immediately after the density control processing, the calibration patch image formation serves also to check whether the density control processing was properly executed, which makes it possible to quickly respond to any abnormality found with the apparatus. Where it is determined to form a calibration patch image upon acceptance of an image formation request, it is possible to calibrate the toner counter in an operating environment which resembles the conditions under which images are actually formed. Further, for even more accurate calculation, calibration patch images may be formed and the toner counter may be calibrated for every certain periods or in accordance with the number of formed images, in addition to this timing.

Under operating conditions set as a result of the density control processing, one calibration patch image may be formed for each color to this end. This permits calibration patch image formation while forming an image in accordance with a print job fed from an external apparatus for instance. As long as the locations of forming calibration patch images are set appropriately, the calibration patch image formation will not deteriorate the throughput of image formation in response to a user's request.

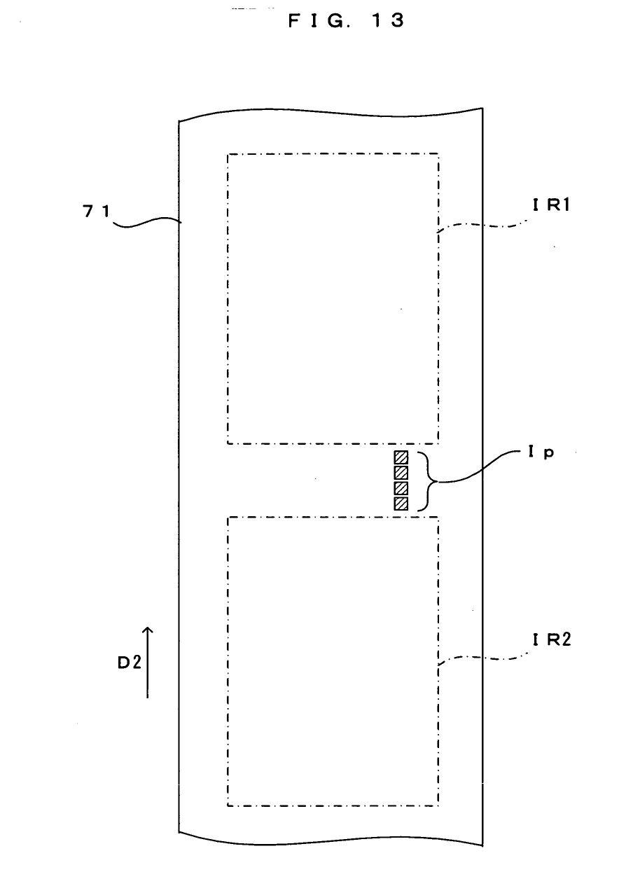

FIG. 13 is a drawing which shows the locations of calibration patch images on the intermediate transfer belt. Calibration patch images only need be large enough for the density sensor 60 to detect them, and may each be a few millimeters times a few millimeters for instance. It is therefore possible to form calibration patch images in the margins which are inevitably spaced when an image corresponding to a request received from outside is formed on the intermediate transfer belt 71. In this case, the calibration patch images may be formed either before or after the image corresponding to the external request, i.e., even on the side of the image corresponding to the external request as long as the density sensor 60 can read them. However, the detected density values of these calibration patch images must be made available to the CPU 101 at latest by the time that calculation of the toner consumption amount for this image starts. In short, the requirement here is that detection of the densities of these calibration patch images finishes before calculation of the toner consumption amount and the apparatus is ready for determination of the coefficient K.

Particularly when plural pages of images are included in a series of jobs, calibration patch images Ip may be formed between surface regions IR1 and IR2 on the intermediate transfer belt 71 within which images corresponding to these pages are formed. This is because it is necessary to separate these regions from each other by a certain distance for separation of the images regardless of whether there should be calibration patch images and because formation of calibration patch images between these regions will not deteriorate the throughput of the image formation. While the calibration patch images Ip in FIG. 13 are four little images, these correspond to the four toner colors. One calibration patch image is sufficient for one toner color.

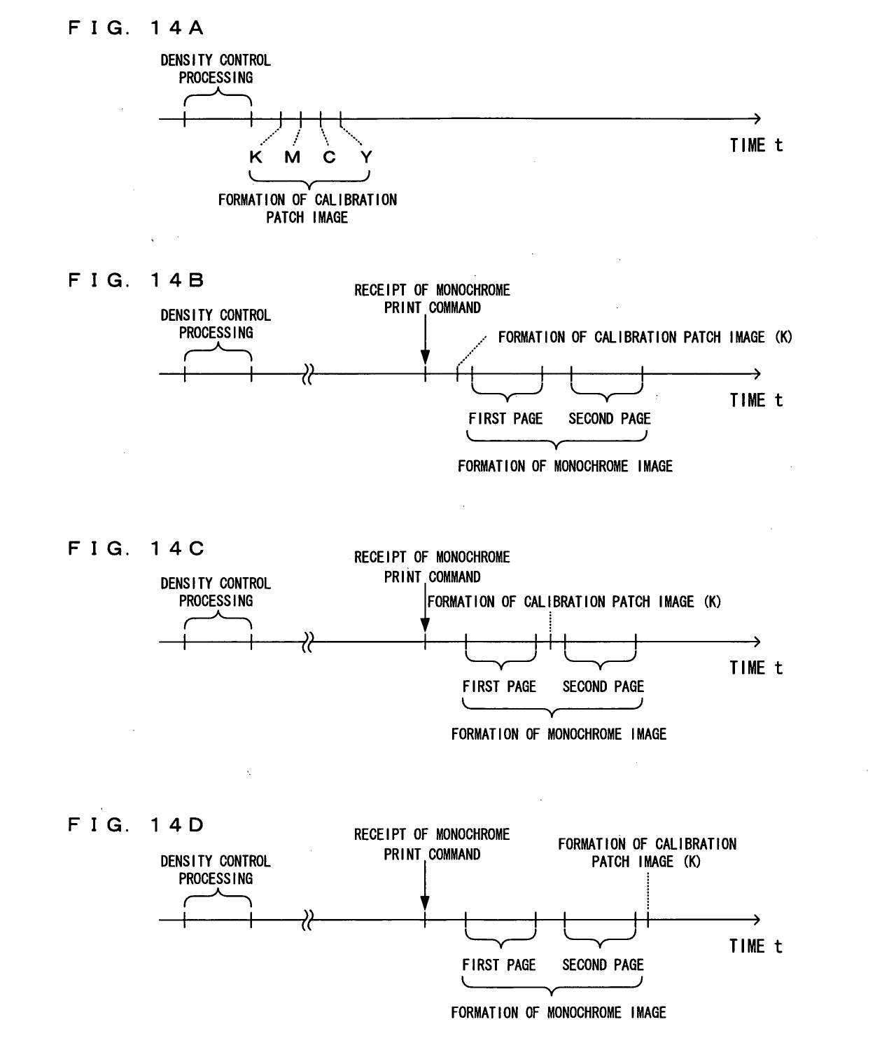

FIGS. 14A, 14B, 14C and 14D are drawings which show timing for forming calibration patch images. First, when the procedure is to form calibration patch images immediately after the density control processing, the calibration patch images for the respective toner colors are formed one after another after the density control processing ends as shown in FIG. 14A. With this complete, as soon as an image formation request arrives from an external apparatus, an image can be formed quickly and the associated toner consumption amount can be calculated quickly without forming calibration patch images again.

When the procedure is to receive an image formation request first and then form calibration patch images after the density control processing, it is preferable that the subsequent processing becomes different depending upon whether an image to form is a monochrome image or a color image. This is because it is not necessary to form calibration patch images right away for the other colors than the color demanded for monochrome formation when an image to form is a monochrome image: skipping calibration patch image formation for the other colors on the contrary saves toner.

That is, when a print command from outside asks for a monochrome image, as shown in 14B, 14C and 14D, calibration patch images of the same color may be formed before printing the first page of the monochrome image corresponding to the command, between pages or after printing all pages. As for calibration patch images for the other colors, they may be formed in the manner described below upon receipt of a command which demands formation of a color image. At this stage, with respect to the monochrome printing color for which calibration patch image formation has already completed, whether to form calibration patch images in this color again or not may be freely determined.

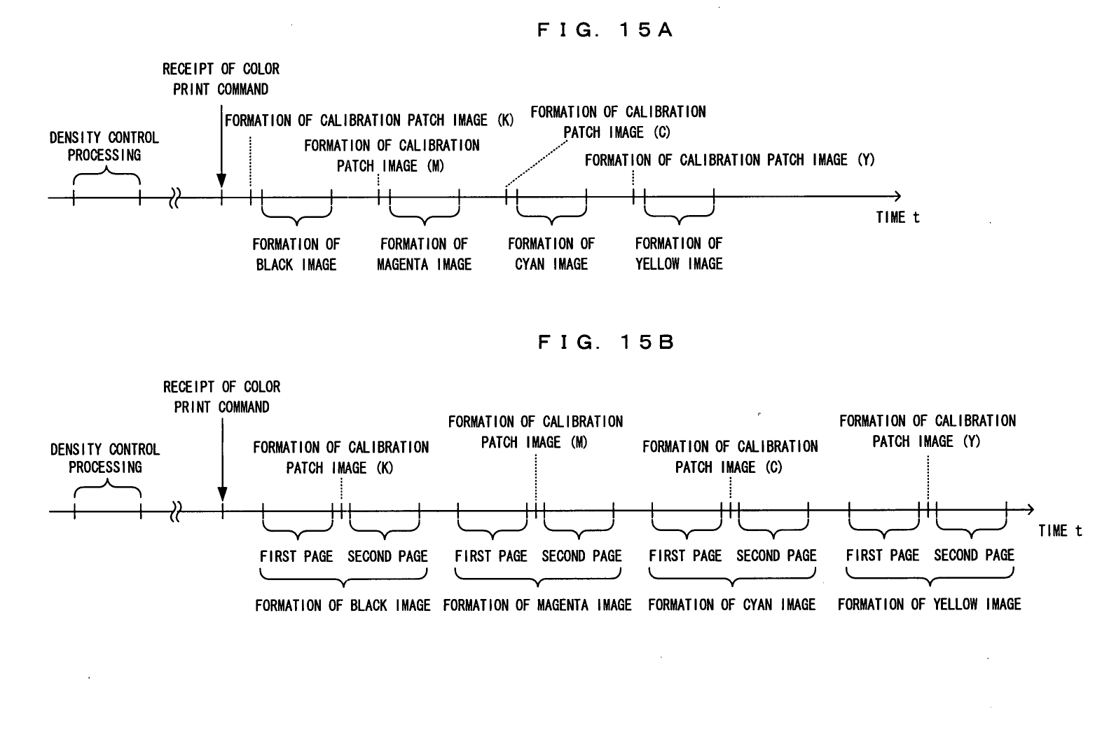

FIGS. 15A and 15B are drawings which show timing for forming calibration patch images in a color print mode. In the event that the first image to form after the density control processing is a full color image, calibration patch images may be formed concurrently with formation of the first image. Since it is necessary to switch the developers during the process of forming a color image, execution of calibration patch image formation alone as an independent sequence will end up in rotating the rotary developer unit 4 only for this purpose. Noting this, at the time of forming a color image corresponding to an external request, a calibration patch image may be formed in each color while forming a toner image in each color, which attains a better efficiency.

First, when an image to form is in one page, as shown in FIG. 15A, at the time of forming toner images in the respective colors one after another in response to a print command which demands printing of a color image, calibration patch images in the respective colors may be formed before or after these toner images. If it is possible during this to detect the density of the calibration patch image in one color and eliminate the calibration patch image prior to formation of the calibration patch image of the next color, the calibration patch images in the respective colors may be formed at the same location on the intermediate transfer belt 71. If this is impossible, the calibration patch images in the respective colors may be formed at different locations as shown in FIG. 13 so that the calibration patch images will not lie one atop the other. When an image to form is over plural pages, calibration patch images may be formed between one page and the next page as shown in FIG. 15B.

As described above, in this embodiment, calibration patch images whose image pattern is suitable for calibration of the toner counter 200 are formed and the toner counter 200 then calculates a toner consumption amount based on the detected densities of the calibration patch images and image data regarding an image to be formed. To be more specific, based on image data regarding each toner color, the number of dots to be formed or values which additionally consider tone values of the respective dots are integrated, and the integrated value Cdot is multiplied by the proportional coefficient K calculated from the detected densities of the calibration patch images, whereby the total toner consumption amount TC is calculated. Using the image forming apparatus having the structure above and the toner counter having the structure above, it is possible to accurately calculate a toner consumption amount.

To be noted in particular, since calibration patch images are formed after adjustment of the operating conditions for the apparatus through the density control processing and the coefficient K is set in accordance with the detected densities of the calibration patch images, it is possible to calculate a toner consumption amount in a state which reflects the adjusted operating conditions. In addition, where an image is actually formed under the operating conditions after the density control processing and the densities are detected, it is possible to deal with fluctuations of a toner consumption amount which even the density control processing can not preclude. Further, as a clue to determine whether the density control processing has been executed properly, the detected densities of the calibration patch images may be used.

Where calibration patch images are formed upon a request for the first image formation after the density control processing instead of immediately after the density control processing, it is possible to calculate a toner consumption amount in a state which resembles actual image formation. In this case, formation of calibration patch images only in a necessary toner color suppresses uneconomic consumption of toner. For example, when the image to be formed is a monochrome image, calibration patch images may be formed only in this monochrome printing color and calibration patch images in the other colors may be formed upon request for formation of a color image. Since the size of calibration patch images is small, the calibration patch images may be formed in the margins around the image to be formed.

Further, since the offset value Coff, which corresponds to the amount of toner consumed irrespective of image data fed from outside, is added to the product of the integrated value Cdot which is based on the image data and the coefficient K which is based on the detected densities of the calibration patch images, it is possible to even more accurately calculate the toner consumption amount in the entire apparatus.

Further, since patch images formed for the density control processing and patch images formed for calibration of the toner counter are distinguished from each other, it is possible to independently select an image pattern which is best suitable to each purpose. In this embodiment, as patch images for the density control processing, solid images and one-ON-ten-OFF images are formed. These image patterns are suitable to calculate optimal values of the developing bias and the exposure power respectively. As patch images for calibration of the toner counter, from among halftone images which easily fluctuate a toner consumption amount, one-ON-one-OFF images are chosen. This makes it possible to suppress an error in toner consumption amount calculation attributable to such fluctuations.

As described above, in this embodiment, the engine part EG functions as the “image forming unit” of the invention, and the intermediate transfer belt 71 disposed to the engine part EG and temporarily carrying a toner image corresponds to the “image carrier” of the invention. The density sensor 60 functions as the “detector” of the invention. The toner counter 200 corresponds to the “toner consumption amount calculator” and the “toner counter” of the invention. The CPU 101 which executes the density control processing functions as the “controller” of the invention. Further, in this embodiment, the two types of patch images (solid images and one-ON-ten-OFF images) formed at the time of the density control processing are the “control patch images” of the invention, while one-ON-one-OFF images formed for calibration of the toner counter are the “calibration patch images” of the invention.

The invention is not limited to the embodiment described above but may be modified in various manners in addition to the embodiment above, to the extent not deviating from the object of the invention. For instance, although the “calibration patch images” are one-ON-one-OFF images which fluctuate a toner consumption amount greatly in the embodiment described above, since toner consumption amount fluctuations are different depending also upon the structure of the apparatus, the characteristic of toner to use and the like, other image pattern may be used in accordance with these factors.

Further, although the embodiment described above requires integrating the number of dots or tone values based on the video signal fed to the laser driver 121 of the engine controller 10 from the pulse modulation part 117 of the main controller 11, this is not limiting. Instead, other data may be used which are indicative of the number of dots to form or how dense the dots are (tone levels, for example).

Further, although the embodiment described above requires forming control patch images and calibration patch images on the intermediate transfer belt 71 and detecting their densities on this belt, this is not limiting. For instance, a density sensor may be disposed facing the photosensitive member 22 and the densities of the patch images may be detected on the photosensitive member 22.

### Second Embodiment

In the first embodiment described above, after optimization of the developing bias Vb and the exposure power E through the density control processing, calibration patch images are formed for calibration of the toner counter. In the second embodiment described below, without forming calibration patch images, the degree of an error in the toner counter is estimated from the degree of a deviation between an ideal operation parameter value for the apparatus and an actual value to which the operation parameter is set, and the count registered by the toner counter is corrected in accordance with the result.

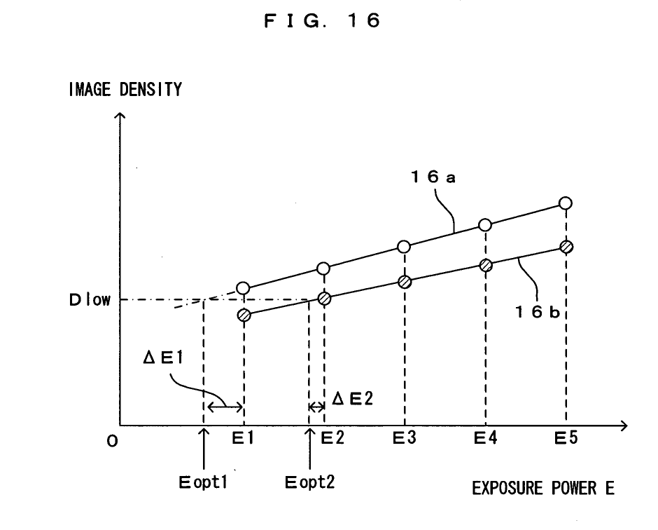

FIG. 16 is a drawing which shows a relationship between the exposure power and the density of an image. The range in which the exposure power can be changed is set in advance, and possible exposure power values are discrete. Hence, an actual value to which the exposure power is set does not necessarily agree with a theoretical optimal value. For instance, when the densities detected at the illustrated exposure power levels are as those denoted at the white circles in FIG. 16, the relationship between the exposure power and the image density is estimated to be like the curve 16a. Although a theoretical optimal value of the exposure power corresponding to the target density Dlow is the value Eopt1 in FIG. 16, this value is outside the exposure power range and the actual value to which the exposure power is set is E1 which is the closest to this theoretical value. Meanwhile, when the densities detected at the respective exposure power levels are as those denoted at the shaded circles in FIG. 16, the relationship between the exposure power and the image density is expressed by the curve 16b, and while the theoretical optimal value of the exposure power is Eopt2, the actual set value is E2 which is equal to or larger than and the closest to the theoretical value Eopt2 from among possible values.

Unless significant enough to be clearly distinguishable to human eyes, such a difference between a theoretical optimal value and an actual set value is not a big problem with respect to the density of an image. However, this difference is a problem for toner consumption amount calculation. This is because the greater a cumulative toner consumption amount becomes and so does a calculation error as the number of formed images grows. To prevent occurrence of a deterioration of an image at unexpected timing because of toner shortage, a conventional toner counter is generally configured such that a theoretical toner consumption amount it calculates is greater than an actual toner consumption amount. This however leads to a determination that toner is in shortage even though there still is toner available within a developer in reality, and may invite a problem that toner will not be used to the end.

In light of this, this embodiment requires changing a formula for calculating a toner consumption amount in accordance with a deviation of a value to which the exposure power E is set from a theoretical optimal value of the exposure power. That is, in an apparatus which holds the exposure power and the density of an image related to each other as expressed by the curve 16a in FIG. 16, the value E1 to which the exposure power is set is higher ΔE1 than the optimal value Eopt1, due to which a toner consumption amount in this apparatus is slightly greater than an estimated toner consumption amount. It is clear that a deviation of an actual toner consumption amount from the estimated value increases as the difference between the value to which the exposure power E is set from the theoretical optimal value becomes greater. Therefore, with a formula for calculating a toner consumption amount changed in accordance with a difference between the value to which the exposure power E is set and the optimal value (hereinafter denoted at ΔE), it is possible to accurately calculate a toner consumption amount.

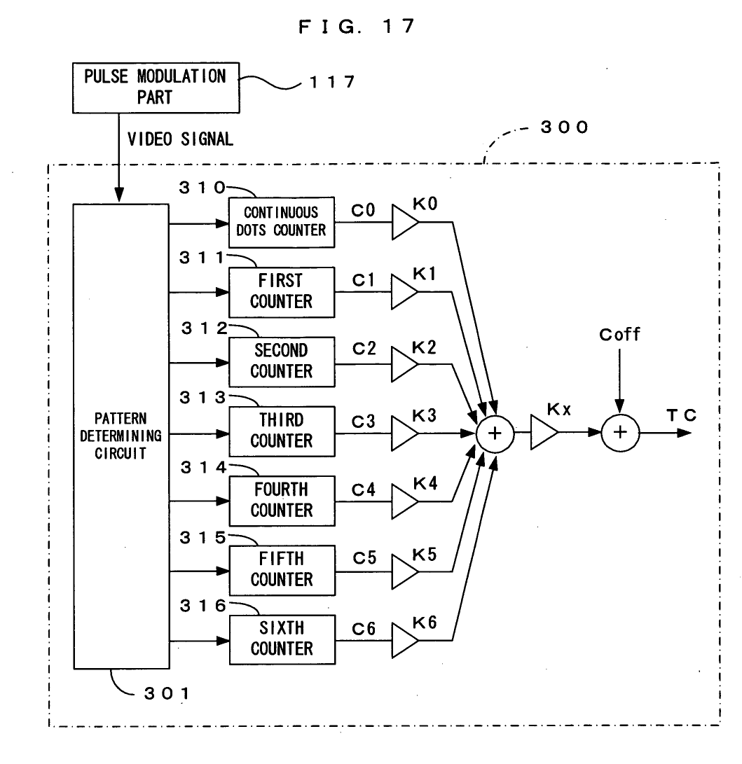

FIG. 17 is a drawing which shows the structure of the toner counter in this embodiment. Based on the video signal fed to the laser driver 121 of the engine controller 11 from the pulse modulation part 117 of the main controller 10, the toner counter 300 counts the number of formed toner dots and a toner consumption amount is calculated from this count. At this stage, instead of merely counting the number of the toner dots, each toner dot is classified in accordance with the gap from the adjacent dot and the number of the toner dots of each category is counted. This is because of the findings described earlier by the inventors of the invention, that is, the amount of toner adhering to each toner dot is different depending upon how far each toner dot is from other neighboring toner dot. The specific structure for this will now be described.

A pattern determining circuit 301 which determines how toner dots are arranged based on the video signal is disposed to the toner counter 300. In accordance With the gap between each toner dot and an immediately preceding toner dot (hereinafter referred to the “OFF-gap”), the pattern determining circuit 301 classifies each toner dot. To be more specific, when the OFF-gap is zero, that is, when this toner dot appears contiguous to the previous toner dot, the pattern determining circuit 301 outputs the value 1 to a continuous dots counter 310.

When this toner dot appears after a previous toner dot with a gap of one dot, the OFF-gap is 1, and in this case, the pattern determining circuit 301 outputs the value 1 to a first counter 311. In a similar manner, the value 1 is output to a second counter 312 when the OFF-gap is 2, to a third counter 313 when the OFF-gap is 3, and to a fourth counter 314 when the OFF-gap is 4. The value 1 is output to a fifth counter 315 when the OFF-gap is 5 through 8, and the value 1 is output to a sixth counter 316 when the OFF-gap is 9 or greater.

The continuous dots counter 310 and the first through the sixth counters 311 through 316 integrate values which the pattern determining circuit 301 outputs to these counters. Hence, these counters individually count the number of formed toner dots which are classified in accordance with the OFF-gaps. The respective counters output thus integrated counts C0 through C6 in a predetermined calculation unit, e.g., per page or job. The counts C0 through C6 are then multiplied by coefficients K0 through K6 which are for weighting the adhering toner amount which changes with the OFF-gap. In this embodiment, with the coefficients K0 through K6 changed in accordance with a deviation ΔE between the value to which the exposure power is set and the optimal value, occurrence of an error in toner consumption amount calculation is suppressed.

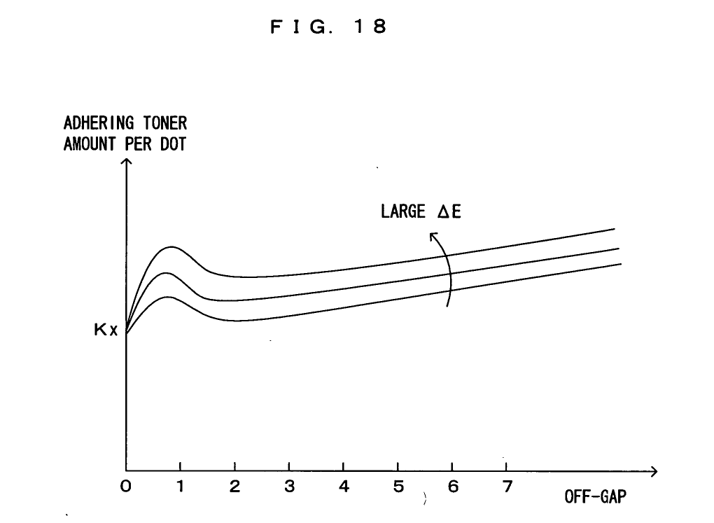

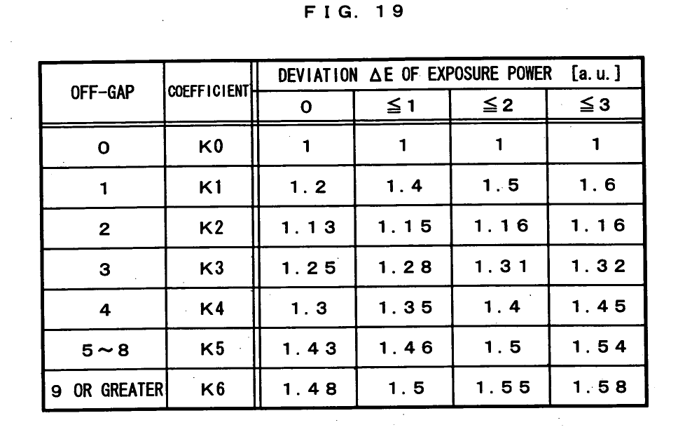

FIG. 18 is a drawing which shows a relationship between the OFF-gap and the adhering toner amount. FIG. 19 is a drawing which shows an example of setting the weighting coefficients. According to experiments by the inventors of the invention, as shown in FIG. 18, the adhering toner amount per toner dot greatly changes depending upon the OFF-gap. The adhering toner amount changes depending upon the deviation ΔE of the exposure power as well. To reflect this trend, the weighting coefficients K0 through K6 are determined as shown in FIG. 19. In FIG. 19, a deviation of the exposure power is expressed in any desired unit, and therefore, the numerical values such as 0 and 3 do not have any particular meaning.

The toner counter 300 will be further described while referring back to FIG. 17. The output values C0 through C6 from the respective counters are multiplied by the weighting coefficients K0 through K6 and then added together, thereby calculating the substantial number of the toner dots weighted in accordance with the different adhering toner amounts. As this value is multiplied by a coefficient Kx which corresponds to the adhering toner amount per dot in a solid image, the amount of toner consumed for formation of each toner dot is calculated. The value TC calculated by adding the offset value Coff to this value is the toner consumption amount in this embodiment. The offset value Coff has same meaning as the offset value of the first embodiment described earlier. In other words, the toner consumption amount TC is expressed by the following formula in this embodiment:
TC=Kx(K0·C0+K1·C1+ . . . +K5·C5+K6·C6)+Coff

As described above, considering a possibility that the density of an image formed under the current operating conditions for the apparatus is different from a target density which this image is supposed to have, this embodiment requires changing the formula for toner consumption amount calculation based on information which expresses the degree of a density discrepancy. To be more specific, the weighting coefficient to be multiplied upon the number of toner dots is changed in accordance with the deviation ΔE of the exposure power E so as to deal with a fluctuation of the toner consumption amount which is created when a value to which the exposure power is set is different from a theoretical optimal value. This suppresses a calculation error attributable to a difference between the set value of the exposure power and the optimal value and realizes accurate toner consumption amount calculation.

Further, since it is possible to calculate the deviation ΔE of the exposure power through computation which is based on the result of the density control processing, any special structure for calculation accuracy improvement is unnecessary, which makes it possible to suppress the cost of the apparatus.

As described above, in this embodiment, the engine part EG which forms an image based on the video signal functions as the “image forming unit” of the invention, and the video signal corresponds to the “image data” of the invention. The toner counter 300 corresponds to the “toner consumption amount calculator” of the invention. Further, in this embodiment, the developing bias Vb and the exposure power E correspond to the “density controlling factors” of the invention, and the CPU 101 which controls the density controlling factor functions as the “controller” of the invention. The target density Dlow for exposure power adjustment corresponds to the “target density” of the invention, while the deviation ΔE between the value to which the exposure power is set and an optimal value corresponds to the “discrepancy information” of the invention.

The invention is not limited to the embodiment described above but may be modified in various manners in addition to the embodiment above, to the extent not deviating from the object of the invention. For instance, although the embodiment described above requires calculating a toner consumption amount in accordance with the principle that the deviation ΔE of the exposure power is used as the “discrepancy information” and a calculation formula is determined in accordance with this value. Alternatively, an approximate toner consumption amount may be calculated by a conventional toner count technique (which does not take discrepancy information into consideration) and the approximate toner consumption amount may be corrected using discrepancy information for improvement of the calculation accuracy.

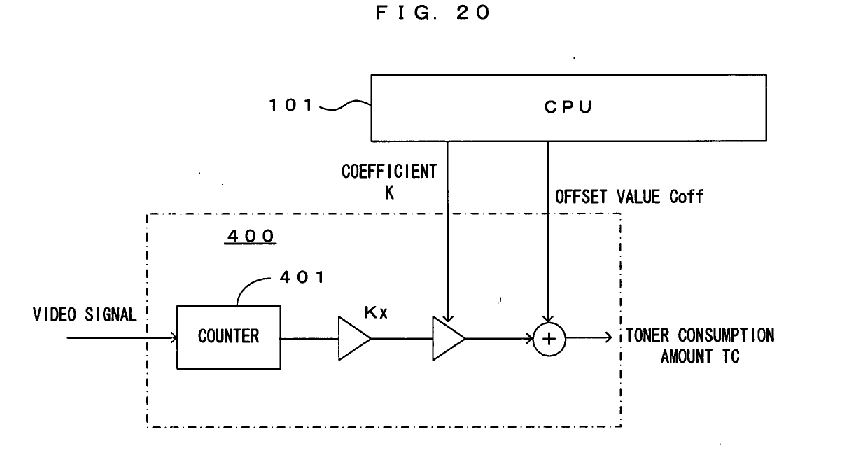

FIG. 20 is a drawing which shows other structure of the toner counter. In this toner counter 400, a counter 401 counts the number of formed toner dots based on the video signal. The count is multiplied by the coefficient Kx which corresponds to the adhering toner amount per dot, thereby calculating an approximate toner consumption amount. At this stage, the degree of a discrepancy between an actual image density and a target density is not considered and therefore the approximate toner consumption amount could include a calculation error. Hence, with the correction coefficient K set by the CPU 101 from the discrepancy information for correction of the approximate value in accordance with the degree of the discrepancy, the calculation accuracy further improves. The offset value Coff may be added further as in the embodiment described above.

Further, the embodiment described above does not require actually measuring a difference between the actual density of a formed image and a target density, but rather uses the deviation ΔE of the value to which the exposure power is set and which influences the image density from the theoretical optimal value as a parameter which indirectly expresses the degree of an image density deviation, namely, the discrepancy information of the invention. On the contrary, the actual density of a formed image may be detected and the discrepancy information may be yielded from the detected density. For instance, when an image to be formed contains a known image pattern, the density sensor 60 may detect the image density within this region and the image density may be compared with an ideal image density estimated from this image pattern to thereby calculate the discrepancy information. In this case, the density sensor 60 functions as the “detector” of the invention.

Further, although the embodiment described above requires changing the formula for toner consumption amount calculation in accordance with the value of the deviation ΔE of the exposure power which is the discrepancy information for example, the “discrepancy information” may alternatively be the amount of a deviation if any of a value to which the developing bias Vb is set from an optimal value. This similarly applies to where other parameter serves as the density controlling factor.

Further, although a value to which the exposure power E is set is the “value which is equal to or larger than and the closest to the optimal value from among possible values” in the above embodiment, the set value of the exposure power E may be used as the closest value to the optimal value. In this case, since the deviation ΔE of the exposure power could be a negative value, coefficients dealing with this need be prepared. The deviation is not limited to a difference between the set value and the optimal value but may rather be expressed by a ratio of the two.

Further, although the embodiment described above requires counting the number of formed toner dots and multiplying the count by a coefficient for calculation of a toner consumption amount, when each toner dot is expressed by multi-tone value, tone values of the respective dots may be integrated instead of counting the number of the toner dots.

Further, in this type of image forming apparatus, the characteristics of the engine part EG, toner and the like change depending upon an environmental change such as a change of the temperature inside the apparatus, the humidity or the like, which may change a toner consumption amount. For instance, experiments by the inventors of the invention confirmed the phenomenon that even under the same operating conditions, a high temperature and humidity level increased a toner consumption amount. It is possible to estimate the degree of a fluctuation from the degree of an environmental change surrounding the apparatus. The amounts of changes of the temperature, the humidity and the like inside (or around) the apparatus may be used as the discrepancy information and the method of toner consumption amount calculation may be changed noting this, thereby making it possible to accurately and stably calculate a toner consumption amount irrespective of such an environmental change. For example, in the event that the temperature inside the apparatus at the time of execution of the density control processing is stored and a toner consumption amount is calculated later, a difference between the temperature inside the apparatus at the time of calculation and the stored internal temperature corresponding to execution of the density control processing may be used as the discrepancy information and the calculation formula may be changed in accordance with the discrepancy information value.

A change of the characteristic of the apparatus with time may also change a toner consumption amount. Noting this, the operating amount of the apparatus (which may be the number of formed images or the operating time for instance) may be measured and the measurement may be used as the discrepancy information of the invention.

Further, although the embodiment described above requires integrating the number of dots based on the video signal fed to the laser driver 121 of the engine controller 10 from the pulse modulation part 117 of the main controller 11, this is not limiting. Instead, other data may be used which are indicative of the number of dots to form or how dense the dots are (tone levels, for example).

In addition, the invention is not limited to the structures according to the embodiments described above but is applicable also to an apparatus which comprises a developer for black toner alone and forms a monochrome image, an apparatus which comprises other transfer medium (which may be a transfer drum, a transfer sheet, etc.) than an intermediate transfer belt, and other image forming apparatus such as a copier machine and a facsimile machine.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
an image forming unit which forms a toner image which corresponds to image data;
a detector which detects density of the toner image formed by the image forming unit; and
a toner consumption amount calculator which calculates a toner consumption amount demanded by the image forming unit,
wherein the image forming unit forms a toner image serving as a calibration patch image, and
the toner consumption amount calculator calculates the toner consumption amount based on the image data and a density detection result regarding the calibration patch image obtained by the detector.

2. The image forming apparatus of claim 1, wherein the toner consumption amount calculator calculates the toner consumption amount by multiplying number of toner dots to be formed by the image forming unit as required by the image data by a coefficient set based on the density detection result.

3. The image forming apparatus of claim 1, wherein the toner consumption amount calculator calculates the toner consumption amount by multiplying an integrated value of tone values of toner dots to be formed by the image forming unit as required by the image data by a coefficient set based on the density detection result.

4. The image forming apparatus of claim 1, further comprising a controller which executes control processing of making the image forming unit form a toner image which serves as a control patch image, making the detector detect the density of the control patch image, and adjusting an operating condition for the apparatus based on this detection result, to thereby control the density of the toner image.

5. The image forming apparatus of claim 4, wherein the image forming unit forms the calibration patch image whose image pattern is different from that of the control patch image immediately after execution of the control processing.

6. The image forming apparatus of claim 4, wherein the image forming unit forms the calibration patch image at different timing than execution of the control processing.

7. The image forming apparatus of claim 4, wherein after execution of the control processing, the image forming unit forms the calibration patch image immediately before or after formation of a first toner image which takes place in response to an image formation request received from outside, and
the toner consumption amount calculator calculates the toner consumption amount demanded by formation of the toner image based on the density detection result regarding the calibration patch image and image data corresponding to the toner image.

8. The image forming apparatus of claim 7 which is capable of executing a monochrome image formation mode for forming a monochrome image consisting of a toner image of one toner color and a color image formation mode for forming a color image which is obtained by laying toner images of plural mutually different colors one atop the other,
wherein when a mode executed first after execution of the control processing is the monochrome image formation mode, the image forming unit forms the calibration patch image only in the toner color which is used for monochrome image formation.

9. The image forming apparatus of claim 8, wherein the image forming unit forms the calibration patch image in all toner colors of the plural colors during execution of the color image formation mode which is executed first after execution of the control processing.

10. The image forming apparatus of claim 1, wherein the image forming unit comprises an image carrier which is capable of temporarily carrying a toner image, and the image forming unit forms the calibration patch image in a region within a surface of the image carrier which is different from a region where a toner image is formed in response to an image formation request received from outside.

11. The image forming apparatus of claim 1, wherein the calibration patch image is a halftone image.

12. An image forming apparatus, comprising:
an image forming unit which forms a toner image which corresponds to image data; and
a toner consumption amount calculator which calculates a toner consumption amount demanded by the image forming unit,
wherein the toner consumption amount calculator calculates the toner consumption amount based on discrepancy information, which expresses a degree of a discrepancy between an actual density of the toner image formed by the image forming unit and a target density which the toner image is supposed to have, and the image data.

13. The image forming apparatus of claim 12, wherein the discrepancy information is information which is indicative of a difference between an actual operating condition for the image forming unit and an ideal operating condition which is an operating condition which attains the target density.

14. The image forming apparatus of claim 12, wherein the toner consumption amount calculator calculates the toner consumption amount by multiplying number of toner dots to be formed by the image forming unit as required by the image data by a coefficient set based on the density detection result.

15. The image forming apparatus of claim 12, wherein the toner consumption amount calculator calculates the toner consumption amount by multiplying an integrated value of tone values of toner dots to be formed by the image forming unit as required by the image data by a coefficient set based on the density detection result.

16. The image forming apparatus of claim 12, wherein the toner consumption amount calculator calculates an approximate value of the toner consumption amount based on the image data and calculates the toner consumption amount by correcting the approximate value based on the discrepancy information.

17. The image forming apparatus of claim 16, wherein the toner consumption amount calculator calculates the toner consumption amount by multiplying number of toner dots to be formed by the image forming unit as required by the image data or number obtained by multiplying the number of the toner dots by a predetermined proportional coefficient as the approximate value, by a correction coefficient set based on the discrepancy information.

18. The image forming apparatus of claim 16, wherein the toner consumption amount calculator calculates the toner consumption amount by multiplying an integrated value of tone values of toner dots to be formed by the image forming unit as required by the image data or a value obtained by multiplying the integrated value by a predetermined proportional coefficient as the approximate value, by a correction coefficient set based on the discrepancy information.

19. The image forming apparatus of claim 12, further comprising a controller which determines within a predetermined range a set value to which a density controlling factor influencing an image density is set and accordingly controls the image density to the target density,
wherein when an optimal value of the density controlling factor corresponding to the target density is outside the range, the controller determines that the set value of the density controlling factor is a closer one to the optimal value between an upper limit value and a lower limit value of the range, and the toner consumption amount calculator uses a difference between the set value and the optimal value as the discrepancy information.

20. The image forming apparatus of claim 12, further comprising a controller which selects a set value to which a density controlling factor influencing an image density is set from among plural candidate values determined in advance and accordingly controls the image density to the target density,
wherein when an optimal value of the density controlling factor corresponding to the target density is not among the candidate values, the controller determines that the set value of the density controlling factor is a closest one to the optimal value among the candidate values, and the toner consumption amount calculator uses a difference between the set value and the optimal value as the discrepancy information.

21. The image forming apparatus of claim 12, further comprising a controller which adjusts a density controlling factor influencing an image density and accordingly controls the image density to the target density,
wherein the toner consumption amount calculator uses a difference between an environment surrounding the apparatus at a time of execution of the control processing and a current environment surrounding the apparatus as the discrepancy information.

22. The image forming apparatus of claim 12, further comprising a detector which detects the image density of the toner image formed by the image forming unit,
wherein the toner consumption amount calculator uses, as the discrepancy information, a difference between the image density of the toner image detected by the detector and an ideal image density which the toner is supposed to have.

23. A toner counter for use within an image forming apparatus for forming a toner image corresponding to image data, which calculates a toner consumption amount demanded by formation of this toner image, comprising:
a counting element which integrates number of toner dots to be formed or tone values of the toner dots based on the image data; and
a calculator which calculates the toner consumption amount based on a density detection result regarding a toner image which serves as a calibration patch image and the count registered by the counting element.

24. A toner counter for use within an image forming apparatus for forming a toner image corresponding to image data, which calculates a toner consumption amount demanded by formation of the toner image, comprising:
a counting element which integrates number of toner dots to be formed or tone values of the toner dots based on the image data; and
a calculator which calculates the toner consumption amount based on discrepancy information, which is indicative of a degree of a discrepancy between an actual density of the toner image thus formed and a target density which is an image density which the toner is supposed to have, and the count registered by the counting element.

25. A toner consumption amount calculation method of calculating a toner consumption amount which an image forming apparatus for forming a toner image corresponding to image data demands for toner image formation, comprising the steps of:
forming a toner image which serves as a calibration patch image;
detecting density of the calibration patch image; and
calculating the toner consumption amount based on the detected density of the calibration patch image and the image data.

26. A toner consumption amount calculation method of calculating a toner consumption amount which an image forming apparatus for forming a toner image corresponding to image data demands for toner image formation, comprising the steps of:
acquiring discrepancy information, which is indicative of a degree of a discrepancy between an actual density of the toner image thus formed and a target density which is an image density which the toner is supposed to have; and
calculating the toner consumption amount based on the discrepancy information and the image data.
